(19) United States
(12) Patent Application Publication
(10) Pub. No.: US 2013/0265283 A1
(43) Pub. Date: Oct. 10, 2013

(54) OPTICAL OPERATION SYSTEM

(71) Applicants: CHUN-YI LU, Hsinchu (TW); Yuan-Yu Peng, Hsinchu (TW); Yu-Chia Lin, Hsinchu (TW); Tzung-Min Su, Hsinchu (TW)

(72) Inventors: CHUN-YI LU, Hsinchu (TW); Yuan-Yu Peng, Hsinchu (TW); Yu-Chia Lin, Hsinchu (TW); Tzung-Min Su, Hsinchu (TW)

(73) Assignee: PixArt Imaging Inc., Hsinchu City (TW)

(21) Appl. No.: 13/586,823

(22) Filed: Aug. 15, 2012

(30) Foreign Application Priority Data
Apr. 10, 2012 (TW) 101112664

(51) Int. Cl. G06F 3/042

(52) U.S. Cl. 345/175

(57) ABSTRACT

An optical operation system includes an image sensing apparatus and a processing circuit. The image sensing apparatus is disposed at an edge of an operation plane and includes a first sensing array and a second sensing array. The first sensing array is configured to capture images at a first height above the operation plane and accordingly generate a first output signal. The second sensing array is configured to capture images at a second height above the operation plane and accordingly generate a second output signal; wherein the first height is greater than the second height. The processing circuit is electrically connected to the image sensing apparatus and configured to receive the first output signal and the second output signal and accordingly generate a first control command and a second control command, respectively.

### TECHNICAL FIELD

The present invention relates to a technology in an optical operation system field, and more particularly to an optical operation system capable of determining an object being in a hover state.

### BACKGROUND

Multi-touch mouse (for example, EvoMouse) is a type of optical operation system that allows a user to use his or her finger gestures to control a computer system. This optical operation system can be implemented as a virtual input device, such as a keyboard or mouse; and thereby providing a convenient operation interface to users.

However, the conventional optical operation system can only determine two-dimensional positions and cannot distinguish the two operations “touch” and “hover” of a sensed object.

### SUMMARY OF EMBODIMENTS

Therefore, one object of the present invention is to provide an optical operation system capable of determining whether or not an object is in a hover state.

The present invention provides an optical operation system, which includes an image sensing apparatus and a processing circuit. The image sensing apparatus is disposed at an edge of an operation plane and includes a first sensing array and a second sensing array. The first sensing array is configured to capture images at a first height above the operation plane and accordingly generate a first output signal. The second sensing array is configured to capture images at a second height above the operation plane and accordingly generate a second output signal; wherein the first height is greater than the second height. The processing circuit is electrically connected to the image sensing apparatus and configured to receive the first output signal and the second output signal and accordingly generate a first control command and a second control command, respectively.

The present invention further provides an optical operation system, which includes an image sensing apparatus and a processing circuit. The image sensing apparatus is disposed at an edge of an operation plane and includes a first sensing array and a second sensing array. The first sensing array is configured to capture images at a first height above the operation plane and accordingly generate a first output signal. The second sensing array is configured to capture images at a second height above the operation plane and accordingly generate a second output signal; wherein the first height is greater than the second height. The processing circuit is electrically connected to the image sensing apparatus and configured to activate the first sensing array so as to receive the first output signal and determine whether or not to activate the second sensing array according to the first output signal.

The present invention still further provides an optical operation system, which includes an image sensing apparatus and a processing circuit. The image sensing apparatus is disposed at an edge of an operation plane and includes a first sensing array and a second sensing array; wherein the first sensing array is arranged above the second sensing array. The first sensing array and the second sensing array are configured to capture images above the operation plane and accordingly generate a first output signal and a second output signal, respectively. The processing circuit is electrically connected to the image sensing apparatus and configured to receive the first output signal and the second output signal and accordingly generate a first control command and a second control command, respectively.

In summary, through arranging two sensing arrays in an image sensing apparatus and using the two sensing arrays to respectively capture images at two different heights above an operation plane, the optical operation system according to the present invention can effectively determine an object above the operation plane whether or not in a hover state according to the images captured by the two sensing arrays.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic top view of an optical operation system in accordance with an embodiment of the present invention;

FIG. 2 is a schematic view illustrating the disposing position of the two sensing arrays in the image sensing apparatus shown in FIG. 1; and

FIG. 3 is a schematic top view of an optical operation system in accordance with another embodiment of the present invention.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

### First Embodiment

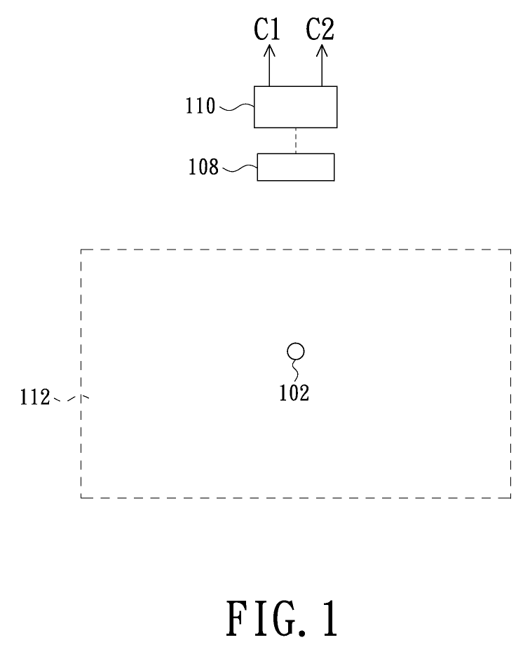

FIG. 1 is a schematic top view of an optical operation system in accordance with an embodiment of the present invention. As shown, the optical operation system in this embodiment includes an image sensing apparatus 108 and a processing circuit 110. The image sensing apparatus 108 is disposed on an edge of an operation plane 112 and configured to sense an object 102 (for example, a user's index finger) on the operation plane 112. In this embodiment, the operation plane 112 is a parallelogram; and specifically the operation plane 112 is a rectangle in a preferred embodiment. In addition, the operation plane 112 can be a real plane (for example, a display panel of a displaying apparatus) or a virtual plane.

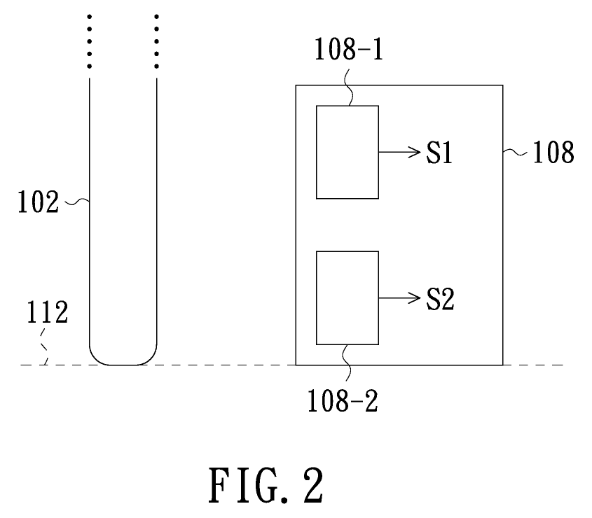

In the embodiment, the image sensing apparatus 108 includes two sensing arrays as illustrated in FIG. 2, which is a schematic view illustrating the disposing position of the two sensing arrays in the image sensing apparatus 108. As shown, the image sensing apparatus 108 includes two sensing arrays 108-1, 108-2; each is configured to capture images located above the operation plane 112. Specifically, the higher sensing array 108-1 is configured to capture images having a first height relative to the operation plane 112 and generate an output signal S1 according to the captured images, and the lower sensing array 108-2 is configured to capture images having a second height relative to the operation plane 112 and generate an output signal S2 according to the captured images; wherein the first height is greater than the second height. Please refer to FIGS. 1, 2 both. The processing circuit 110 is electrically connected to the image sensing apparatus 108 and configured to receive the output signals S1, S2 from the sensing arrays 108-1, 108-2 and accordingly output control commands C1, C2, respectively.

Because the two sensing arrays 108-1, 108-2 in the image sensing apparatus 108 are configured to capture images with two different heights relative to the operation plane 112, the processing circuit 110 can determine that whether or not the object 102 is in a hover state according to the images captured by the two sensing arrays 108-1, 108-2 (specifically, according to the output signals S1, S2 outputted from the sensing arrays 108-1, 108-2, respectively). In other words, the object 102 is determined in a hover state if the object 102 is captured by the sensing array 108-1 only; and accordingly, the processing circuit 110 can indicate that the object 102 is in a hover state through the control command C1. It is to be noted that the processing circuit 110 can further use the control command C1 for indicating a movement state of the object 102. For example, instead of being used to indicate a hover state, the control command C1 can further be used for indicating a movement state of the object 102 if the object 102 has been in the hover state for a determined time.

Additionally, in order to have a power saving feature, the processing circuit 110 can be configured to activate the sensing array 108-2 only when specific object information (for example, some specific information associated with the object 102) is delivered in the output signal S1 outputted from the processing circuit 110. In other words, the processing circuit 110 may activate the sensing array 108-1 first, and then determine whether or not to activate the sensing array 108-2 according to the output signal S1 outputted from the sensing array 108-1. Therefore, the sensing array 108-1 only needs to determine whether the object 102 is sensed or not, and there is no need to determine the coordinate of the object 102 by the sensing array 108-1.

It is to be noted that the sensing arrays 108-1, 108-2 both can be integrated on a single sensor chip; alternatively, the sensing arrays 108-1, 108-2 can be implemented on two individual sensor chips, respectively. Moreover, it is to be noted that the sensing arrays 108-1, 108-2 can be respectively disposed at two different positions on an edge of the operation plane 112. In addition, the optical operation system in the present invention can be a touch system or a handwriting system.

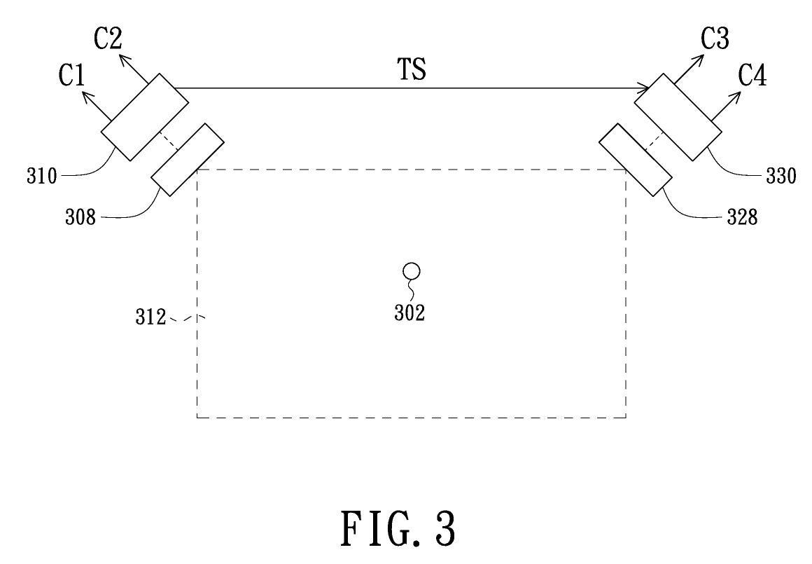

Based on the aforementioned descriptions, it is understood that the optical operation system in the present invention is not limited to one image sensing apparatus and one processing circuit. In other words, the optical operation system in another embodiment can be implemented by more than one image sensing apparatus and more than one processing circuit, as illustrated in FIG. 3.

FIG. 3 is a schematic top view of an optical operation system in accordance with another embodiment of the present invention. As shown, the optical operation system in this embodiment further includes, beside a pair of an image sensing apparatus 308 and a corresponding processing circuit 310, another pair of an image sensing apparatus 328 and a corresponding processing circuit 330. The image sensing apparatuses 308, 328 each are disposed on an edge of an operation plane 312 and configured to sense an object 302 on the operation plane 312 individually. In this embodiment, the image sensing apparatuses 308, 328 each include two sensing arrays; wherein the two sensing arrays in the image sensing apparatus 308 or 328 are arranged same as the view illustrated in FIG. 2. The processing circuit 310 is electrically connected to the image sensing apparatus 308 and configured to receive the two output signals from the two sensing arrays therein and accordingly output the control commands C1, C2, respectively. The processing circuit 330 is electrically connected to the image sensing apparatus 328 and configured to receive the two output signals from the two sensing arrays therein and accordingly output the control commands C3, C4, respectively.

In this embodiment, the processing circuit 310 is configured to activate the higher sensing array in the image sensing apparatus 308 first, and then determine whether or not to activate the lower sensing array in the image sensing apparatus 308 according to the output signal outputted from the higher sensing array. In addition, at the same time the processing circuit 310 is, while activating the lower sensing array in the image sensing apparatus 308, configured to issue a trigger signal TS to the processing circuit 330 so as to control the processing circuit 330 to simultaneously activate the two sensing arrays in the image sensing apparatus 328. It is to be noted that the image sensing apparatus 328 may include the lower sensing array only, which is for, corporately with the lower sensing array in the image sensing apparatus 308, sensing a specific movement (for example, a two-dimensional movement) of the object 302 on the operation plane 312. Ii is understood that the controlling of the sensing array(s) in the image sensing apparatus 328 is similar to that in the image sensing apparatus 308, and no any unnecessary detail is given here.

In summary, through arranging two sensing arrays in an image sensing apparatus and using the two sensing arrays to respectively capture images at two different heights above an operation plane, the optical operation system according to the present invention can effectively determine an object above the operation plane whether or not in a hover state according to the images captured by the two sensing arrays. In addition, it is to be noted that the optical operation system according to the present invention can also be used in one-camera touch sensing system. In other words, an object's coordinate can be determined by a real image and a mirror image if only one camera is employed with one mirror. Moreover, it is understood that the hover state detection still can be performed if the camera has two sensing arrays as disclosed in the aforementioned descriptions.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical operation system, comprising:
an image sensing apparatus disposed at an edge of an operation plane and comprising a first sensing array and a second sensing array, wherein the first sensing array is configured to capture images at a first height above the operation plane and accordingly generate a first output signal, the second sensing array is configured to capture images at a second height above the operation plane and accordingly generate a second output signal, and the first height is greater than the second height; and
a processing circuit electrically connected to the image sensing apparatus and configured to receive the first output signal and the second output signal and accordingly generate a first control command and a second control command, respectively.

2. The optical operation system according to claim 1, wherein the optical operation system is a touch system.

3. The optical operation system according to claim 1, wherein the optical operation system is a handwriting system.

4. The optical operation system according to claim 1, wherein the first sensing array and the second sensing array are integrated on a single sensor chip.

5. The optical operation system according to claim 1, wherein the first sensing array and the second sensing array are implemented on two individual sensor chips, respectively.

6. The optical operation system according to claim 1, wherein the first sensing array and the second sensing array are respectively disposed at two different positions on an edge of the operation plane.

7. The optical operation system according to claim 1, wherein the second sensing array is activated if the first output signal contains object information.

8. The optical operation system according to claim 1, wherein the first control command is for indicating that an object is in a hover state.

9. The optical operation system according to claim 1, wherein the first control command is for indicating a movement state of an object.

10. An optical operation system, comprising:
an image sensing apparatus disposed at an edge of an operation plane and comprising a first sensing array and a second sensing array, wherein the first sensing array is configured to capture images at a first height above the operation plane and accordingly generate a first output signal, the second sensing array is configured to capture images at a second height above the operation plane and accordingly generate a second output signal, and the first height is greater than the second height; and
a processing circuit electrically connected to the image sensing apparatus and configured to activate the first sensing array so as to receive the first output signal and determine whether or not to activate the second sensing array according to the first output signal.

11. The optical operation system according to claim 10, wherein the optical operation system is a touch system.

12. The optical operation system according to claim 10, wherein the optical operation system is a handwriting system.

13. The optical operation system according to claim 10, wherein the first sensing array and the second sensing array are integrated on a single sensor chip.

14. The optical operation system according to claim 10, wherein the first sensing array and the second sensing array are implemented on two individual sensor chips, respectively.

15. The optical operation system according to claim 10, wherein the first sensing array and the second sensing array are respectively disposed at two different positions on an edge of the operation plane.

16. The optical operation system according to claim 10, wherein the second sensing array is activated if the first output signal contains object information.

17. The optical operation system according to claim 10, wherein the processing circuit is further configured to output a first control command, for indicating that an object is in a hover state, in response to the first output signal.

18. The optical operation system according to claim 10, wherein the processing circuit is further configured to output a first control command, for indicating a movement state of an object, in response to the first output signal.

19. An optical operation system, comprising:
an image sensing apparatus disposed at an edge of an operation plane and comprising a first sensing array and a second sensing array, wherein the first sensing array is arranged above the second sensing array, the first sensing array and the second sensing array are configured to capture images above the operation plane and accordingly generate a first output signal and a second output signal, respectively; and
a processing circuit electrically connected to the image sensing apparatus and configured to receive the first output signal and the second output signal and accordingly generate a first control command and a second control command, respectively.

20. The optical operation system according to claim 19, wherein the optical operation system is a touch system.

21. The optical operation system according to claim 19, wherein the optical operation system is a handwriting system.

22. The optical operation system according to claim 19, wherein the first sensing array and the second sensing array are integrated on a single sensor chip.

23. The optical operation system according to claim 19, wherein the first sensing array and the second sensing array are implemented on two individual sensor chips, respectively.

24. The optical operation system according to claim 19, wherein the first sensing array and the second sensing array are respectively disposed at two different positions on an edge of the operation plane.

25. The optical operation system according to claim 19, wherein the second sensing array is activated if the first output signal contains object information.

26. The optical operation system according to claim 19, wherein the first control command is for indicating that an object is in a hover state.

27. The optical operation system according to claim 19, wherein the first control command is for indicating a movement state of an object.
